(19) United States
(12) Patent Application Publication
(10) Pub. No.: US 2019/0017876 A1
(43) Pub. Date: Jan. 17, 2019

(54) PIR SENSOR AND PHOTOGRAPHING DEVICE

(71) Applicant: JMC ELectron Co., Ltd., Shenzhen (CN)

(72) Inventor: Zheng Li, Shenzhen (CN)

(21) Appl. No.: 15/646,485

(22) Filed: Jul. 11, 2017

(51) Int. Cl. G01J 5/06; G01J 5/02; G01J 5/00; G01J 5/04; H04N 5/225; H04N 5/33; B60R 25/31; B60R 25/30

(52) U.S. Cl. CPC G01J 5/06; G01J 5/0265; G01J 5/0025; G01J 5/04; G01J 5/028; G01J 2005/065; H04N 5/2252; H04N 5/2257; H04N 5/33; B60R 25/31; B60R 25/305; H04N 5/2254

(57) ABSTRACT

The present invention discloses a PIR sensor, including an infrared probe and a lens located between the infrared probe and a detected area, wherein a baffle is provided between the lens and the detected area, a plurality of through holes evenly provided on the baffle. The through holes of the baffle are arranged in a meshy patterns. According to the PIR sensor disclosed by the present invention, the baffle can block the lens, without affecting the performances of the PIR sensor at all, thereby not only improving the aesthetic degree of the product, but also further improving the concealment property of a photographing device.

### TECHNICAL FIELD

The present invention relates to a PIR sensor and a photographing device using the same.

### BACKGROUND

Electronic products such as sensor switches, alarms, infrared thermometers and infrared imaging devices make extensive use of passive infrared sensing (PIR) technique. The PIR sensor because of its low price and stable technical performances is popular among the majority of users. A sensing end of the PIR sensor is typically equipped with a lens that focuses infrared rays of the human body. PIR lenses in existing electronic products are usually exposed directly to the outside of the product, that is, the PIR sensor can be seen directly from the outside of the product, resulting in failing to achieve the purpose of needing to conceal the PIR sensor product. In addition, the PIR lens is relatively low in price of material and incompatible with high-end products in appearance, thereby reducing the product grade in appearance.

### SUMMARY

In order to solve the above-mentioned technical problems in the prior art, the present invention provides an improved PIR sensor having a concealment property and a photographing device to which the PIR sensor is mounted.

The PIR sensor provided by the present invention comprises an infrared probe and a lens located between the infrared probe and a detected area, wherein a baffle is provided between the lens and the detected area, a plurality of through holes evenly provided on the baffle.

The through holes are arranged in a meshy patterns.

The baffle is made of plastic or metal.

The present invention also provides a photographing device using the PIR sensor. The photographing device comprises a housing having an opening at one end, a PIR sensor provided inside the housing and a camera module. The PIR sensor comprises an infrared probe and a lens between the infrared probe and the detected area. A baffle is provided between the lens and the detected area, a plurality of through holes evenly provided on the baffle. The baffle is located at the opening of the housing.

The housing of the photographing device may be a housing of an electronic vehicle key.

In one embodiment, a circuit board is mounted in a housing top of the upper half of the housing, the infrared probe is welded to one end of the circuit board, a lens is provided in front of the infrared probe, and a camera module is provided next to the infrared probe. A pointing direction of a camera lens of the camera module is identical with that of a sensing end of the infrared probe. The opening is a downward square groove, and the baffle is inserted into the square groove from bottom to top.

A night vision lamp electrically connected to the circuit board is provided at the inner side of the baffle, and a light outgoing side of the night vision lamp is provided with a lamp cover for preventing light leakage.

Compared with the prior art, the present invention has the advantages:

according to the PIR sensor and the photographing device disclosed by the present invention, by adding the baffle having the concealment property to the front of the lens of the PIR sensor, the lens is completely concealed at the inner side of the baffle, and only meshes of the baffle can be seen from the front, such that the PIR sensor at the inner side cannot be found to achieve the concealment effect. In addition, the lens that is incompatible with the product in appearance is shielded therein to further improve the artistic property and the consistency of the product. The PIR sensor having the concealment property is applied to the photographing device, such that the photographing device has a function of automatic photographing while sensing an infrared moving source. In addition, the baffle also covers the camera lens of the photographing device, without affecting the photographing function of the photographing device and the sensitivity of the PIR sensor, such that the concealment property of the photographing device is further improved. The photographing device is suitable for a variety of emergencies that should not be taken directly from a mobile phone or a camera

### BRIEF DESCRIPTION OF THE DRAWINGS

FIG. 1 is a schematic drawing of a PIR sensor;

FIG. 2 is an exploded drawing of the PIR sensor used on a photographing device;

FIG. 3 is a schematic drawing of a baffle;

FIG. 4 is an exploded drawing of the PIR sensor adopting a housing of an electronic vehicle key; and

FIG. 5 is an appearance schematic drawing of the photographing device.

### DETAILED DESCRIPTION

The principle and structure of the present invention will now be described in detail with reference to the accompanying drawings and embodiments.

As illustrated in FIG. 1, a PIR sensor provided by the present invention comprises an infrared probe 5 and a lens 6 provided in front of the infrared probe 5. A detected area is provided in front of the lens. A baffle 8 is provided between the lens and the detected area, a plurality of through holes evenly provided on the baffle. The through holes are arranged in a meshy patterns. When an infrared moving source penetrates through the sensing detected area in front of the baffle 8, the infrared probe 5 can normally use the infrared sensing function to transfer signals.

The baffle 8 of the present invention may be made of metal or plastic.

The improved PIR sensor may be used on various electronic products, such as sensor switches, alarms, infrared thermometers and infrared photographing devices and is difficult to be found and unlikely to affect the artistic property and the consistency of the product.

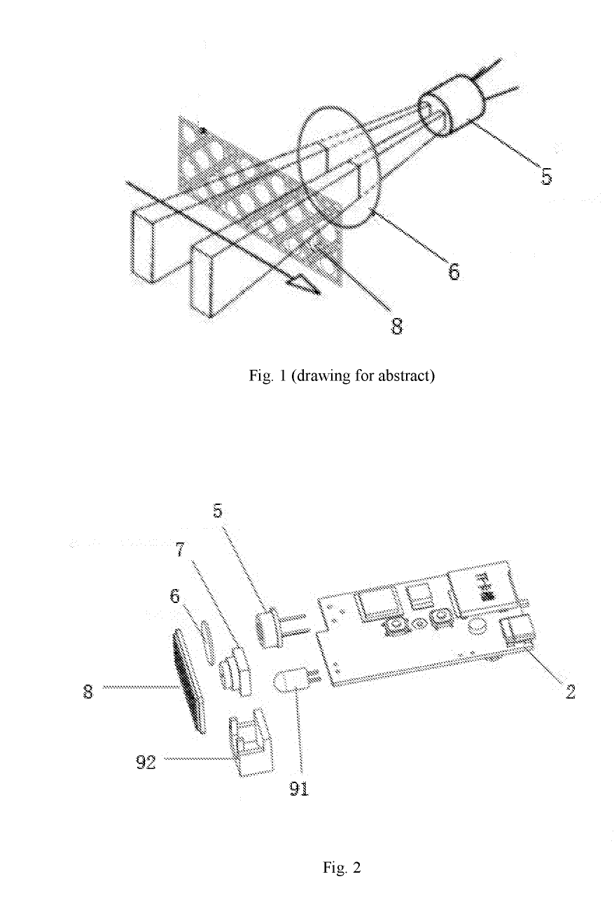

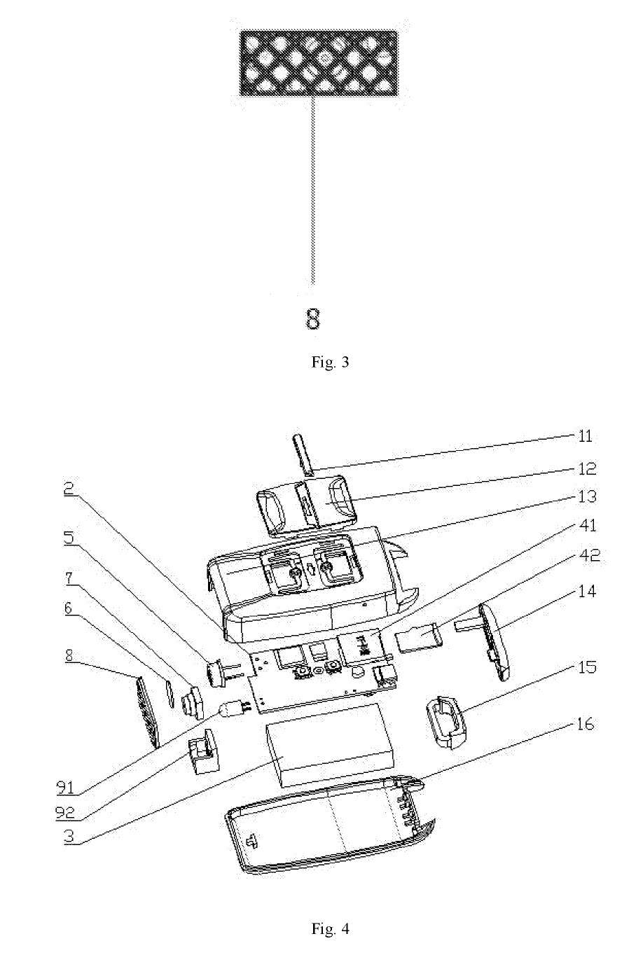

FIGS. 2, 4, and 5 illustrate a photographing device to which the PIR sensor of the present invention is mounted. The photographing device comprises a housing 1 having an opening at one end, wherein the opening is a square groove. A circuit board is cooperatively mounted inside a housing top 13 of the upper half of the housing 1. A battery 3 for supplying power to the circuit board 2 is located below the circuit board 2, such that the top of the battery 3 is attached to the back surface of the circuit board 2 to each other. A bottom housing 16 at a lower half of the housing 1 is provided with a positioning groove which is used for cooperatively fixing the bottom of the battery 3. A TF card slot of a storage device 4 is welded to the circuit board 2. An infrared probe 5 is welded to one end, opposite to the TF card slot 41, of the circuit board 2. A lens 6 that focuses infrared rays of the human body is provided in front of the infrared probe 5. The lens 6 is located between a groove in the end surface of the top housing 13 and the sensing end of the infrared probe 5. A camera module 7 is provided next to the infrared probe 5 and electrically connected to the circuit board 2. A pointing direction of a camera lens of the camera module 7 is identical with that of the sensing end of the infrared probe 5. A baffle 8 that has a structure with holes and meshy patterns is provided at the groove in the end surface of the top housing 13 in a manner of inserting from bottom to top. A light transmission part of the baffle 8 may be in a square or circular shape or any other shapes. As illustrated in FIG. 3, the baffle 8 just covers the sensing end of the infrared probe 5 and the camera lens of the camera module 7. The sensing end of the infrared probe 5 and the camera lens of the camera module 7 can be aligned with a light transmission hole or meshes with meshy patterns of the baffle 8, without affecting the function thereof. In addition, during photographing, it is unlikely to find the camera module 7 and the infrared probe 5 provided at the inner side from the outer side of the baffle 8, thereby improving the concealment property of the present invention. Camera shooting or photographing can be finished under an unperceived condition to deal with various emergencies.

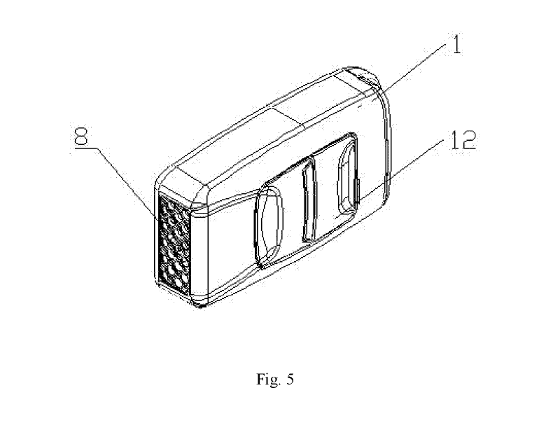

As illustrated in FIG. 4 and FIG. 5, the housing 1 is a housing of an electronic vehicle key. The housing 1 is composed of a key decorative strip 11, a key shell 12, a top shell 13, a rear shell 14, a key ring 15, and a bottom shell 16. The top shell 13 is provided with two square holes corresponding to keys on the circuit board 2, and the pushable U-shaped key strip is provided inside the square holes. The corresponding key shell 12 is buckled into the square holes in the top shell 13. A strip-shaped through hole matched with the key decorative strip 11 is provided in the middle of the key shell 12. The key decorative strip 11 is buckled into the key shell 12. A baffle 8 is inserted to one end of the top shell 13, and then the bottom shell 16 and the top shell 13 are mounted in a matching manner to fix the battery 2 and the circuit board 2 which are internally provided, and the baffle 8 at one end. The key ring 15 provided with a through hole is provided at a square notch at one end of the top shell 13 and is fixed by the rear shell 14 inserted to the top shell 13. After assembling, as illustrated in FIG. 5, the photographing device at the inner side of the baffle 8 can be well concealed. The photographing device may be started by pushing the keys on the key shell 12 in a using process, or the photographing device is placed at a fixed position, the baffle 8 is aligned to a desired photographing direction, and then automatic photographing is performed by means of the automatic sensing of the PIR sensor to the human body. When the photographing device is not used, the photographing device can be buckled on the key ring, to facilitate carrying to deal with the emergent photographing conditions.

A night vision lamp 91 electrically connected to the circuit board 2 is also provided at the inner side of the baffle 8 in this embodiment, and the night vision lamp 91 is sleeved with a lamp cover 92. Therefore, the PIR sensor and the photographing device can be normally used at night. In addition, it is unlikely to find the night vision lamp 91 at the inner side from the outer side of the baffle 8. The night vision lamp 91 has a model of 940 nm or 850 nm.

The contents described above are merely the preferred embodiments of the present invention and are not intended to limit the present invention, and any modifications, equivalent substitutions and improvements within the spirit and principle of the present invention shall fall within the scope of the present invention.

1. A PIR sensor, comprising an infrared probe and a lens provided between an infrared sensor and a detected area, wherein a baffle is provided between the lens and the detected area, a plurality of through holes evenly provided on the baffle.

2. The PIR sensor according to claim 1, wherein the through holes are arranged in a meshy patterns.

3. The PIR sensor according to claim 1, wherein the baffle is made of plastic or metal.

4. A photographing device using the PIR sensor according to claim 1, comprising a housing with an opening at one side, a PIR sensor provided inside the housing and a camera module, wherein the PIR sensor comprises an infrared probe and a lens provided between the infrared probe and the detected area, and a baffle which is located at the opening of the housing is provided between the lens and the detected area, a plurality of through holes evenly provided on the baffle.

5. The photographing device according to claim 4, wherein the through holes are arranged in a meshy patterns.

6. The photographing device according to claim 4, wherein the baffle is made of plastic or metal.

7. The photographing device according to claim 4, wherein the housing is a housing of an electronic vehicle key.

8. The photographing device according to claim 7, wherein a circuit board is mounted inside a housing, the infrared probe is welded to one end of the circuit board, a lens is provided in front of the infrared probe, a camera module is provided next to the infrared probe, a pointing direction of a camera lens of the camera module is identical with that of a sensing end of the infrared probe, the opening is a downward square groove, and the baffle is inserted into the square groove from bottom to top.

9. The photographing device according to claim 4, wherein a night vision lamp connected to the circuit board is also provided at the inner side of the baffle, and a lamp cover for preventing light leakage is provided at a light outgoing side of the night vision lamp.

10. The photographing device according to claim 9, wherein the night vision lamp has a model selected from 940 nm or 850 nm.
